(19) United States
(12) Patent Application Publication
(10) Pub. No.: US 2026/0225434 A1
(43) Pub. Date: Aug. 6, 2026

(54) Vehicle Protector

(71) Applicant: David Charles Short, Melbourne (AU)

(72) Inventor: David Charles Short, Melbourne (AU)

(21) Appl. No.: 19/459,237

(22) Filed: Jan. 26, 2026

Related U.S. Application Data
(63) Continuation-in-part of application No. PCT/AU2024/050790, filed on Jul. 25, 2024.

(30) Foreign Application Priority Data
Jul. 26, 2023 (AU) 2023902378

(51) Int. Cl. B60J 11/06; B60R 11/00

(52) U.S. Cl. CPC B60J 11/06; B60R 11/00; B60R 2011/004; B60R 2011/0057; B60R 2011/0078

(57) ABSTRACT

A complex structure acting as a vehicle protector including three or four sections of resilient structure having hinged sections 28 joined by hinges 30 and preferably with four hinged sections allowing folding to create a unique W shape fold design. Magnets 35 in the segments 28 are offset so as to maintain a distance when in the unfolded in use mode or in the folded storage mode. This means in one example that one segment 28 has two spaced magnets 35 near opposing ends of the first segment and the hingedly attached second segment has a magnet 35 in the middle so that in hingedly folding the two segments the middle magnet will fit within the spacing of the two magnets and maintain a working spacing that does not affect each other.

### CROSS-REFERENCE TO RELATED PATENT APPLICATIONS

This Patent Application is a continuation-in-part of co-pending PCT Patent Application No. PCT/AU2024/050790, filed Jul. 25, 2024, which is now pending, the entire teachings and disclosure of which are incorporated herein by reference thereto. This Patent Application claims Priority to Australian Patent Application No. 2023902378, filed Jul. 26, 2023, the entire teachings and disclosure of which are incorporated herein by reference thereto.

### FIELD OF THE INVENTION

The present invention relates to a vehicle protector and in particular to a temporary vehicle protector that can be readily applied and removed without tools.

The invention has been developed primarily for use with passenger vehicles and will be described hereinafter with reference to this application. However, it will be appreciated that the invention is not limited to this particular field of use.

### BACKGROUND OF THE INVENTION

A vehicle protector can be a fixed hard coating applied to the vehicle over the paintwork. This is effective against corrosive rain, dirt, animal excrement etc. However it is a costly process and is still not effective against the common day-to-day knocks and bumps that a vehicle encounters in enclosed environments.

Those environments can be natural environments where the vehicle glides next to a bush or tree. It can be a building environment like a home driveway where a car is being parked alongside a building. Further it could be a commercial environment like a commercial carpark where there are possible small category taps and knocks by parking vehicles, customers squeezing between vehicles and out of control shopping trolleys that cause damage.

It is known to have car covers and even padded car covers that fully cover the vehicle and tightened with a drawstring. These are very effective if the vehicle is to be left for days or weeks. However, it is not going to be used for day-to-day encounters.

It can be seen that a temporary vehicle protector has the problems of needing to be:
a) Readily transportable
b) Readily locatable in a more likely damaging location
c) not cause damage to the vehicle body
d) readily removable
e) not affect vehicle operation

The present invention seeks to provide a vehicle protector, which will overcome or substantially ameliorate at least one or more of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

According to a first aspect of the present invention, there is provided a vehicle protector having an elongated body for removably affixing to a vehicle for protection comprising a base matrix layer use of the product providing as cushioning effect, a layer of the product acting as a cover and at a spaced location as a live hinge, and a location and the insertion of magnets to provide affixing to a metallic vehicle using a magnetic effect without causing electrical interference. The vehicle protector is able to adapt between a storage folded mode and an unfolded mode in operation for attaching to the vehicle to provide a cushioning protector to the vehicle.

Preferably the base matrix layer is a corrugated structure or a layered structure.

The base matrix layer can be a complex structure having at least one layer of corrugated structure and at least one layer of sheeting.

At least one layer of sheeting can act as a hinge so to allow the elongated body to be folded in a storable and transportable mode.

The complex structure can include a cut line to at least layer of sheeting which acts as a hinge for the complex structure. In this way the complex structure includes three or four sections of a fluted corrugated structure having one side of the channel removed to allow it to be folded. The four sections of the complex structure allow folding to create unique W shape fold design. However other folding arrangements are used.

Preferably the structure of the vehicle protector includes channeling from an upper side to a lower side to provide a drainage structure to resist pooling when used.

The location and insertion of magnets can provide affixing to a metallic vehicle using a magnetic effect without causing electrical interference includes a plurality of 25 mm by 1 mm neodymium magnets supported at spaced positions along the length of the elongated body. Preferably the location and insertion of magnets is beneath outer layers to control magnetic effect. The location and insertion of magnets can be beneath outer layers of 2 or more mm to control magnetic effect.

The invention also provides a method of providing temporary protection to a vehicle including the steps of:
a) Providing a product having a matrix central layer and outer continuous planar layers
b) Providing a continuous elongated shape from the product
c) Providing spaced cuts on outer continuous layer on one side and through the matrix material to form the other outer continuous layer as a live hinge at that location
d) Including insertion of magnets to provide ability to affix to a metallic vehicle using a magnetic effect without causing electrical interference

Cuts can be included in outer continuous layer which are at parallel spaced locations down the elongated shape to form multi folds of the elongated shape. Preferably the cuts are on one or other outer side of the outer continuous layer and are on alternating one or other outer side of the outer continuous layer.

The invention has approached

To design in one piece to minimise any possibility of breaking parts and impact of labour.

To design a product that could be easily stored.

The original product was made from Corex sheet with channels, a vac formed product. As it was cut to size it had sharp edges and the tolerances in measurements were not uniform. The magnets being attached to the outside of the product, whilst having the strongest magnet attraction, required a patch fitting to hold onto the Corex. This produced a problem that if the patch adhesive was loosened the magnet would disengage and remain on the car it was attached to. I designed the new fixing of the magnets in a slot in the material to alleviate the possibility of the magnet from breaking free from the surface of the car protector. The new material was designed to be made from one piece of silicone to eliminate labour and simplify the making of the product.

The design change for the magnets was necessitated because the patch fitting was not being reliable for attaching to the original material. As adhesion to silicon is difficult, I designed the magnets to fit into the profile of the silicon. A pocket was designed to hold the magnet firmly in the centre of the silicone in a small cavity which closed tightly at the top making it difficult to remove the magnets. Because of the surface adhesion of the silicon, it affords friction against the mechanical removal of the magnets.

I decided on using 25 mm×3 mm rare earth neodymium magnets. The magnets have a pull force of 4.8 kg per magnet. The six magnets have a total pull force of 28.8 kg. This total magnet force is easily strong enough to penetrate through the cell wall structure providing strong attraction. The cell guard pro has been tested to 145 kms per hour whilst still adhering strongly to the car door. In the design stage, I considered the advantage of a design that could fold itself into a perfect brick shape for easy storage, by calculating the positive poles of the magnet attracting through the cells of the silicon. I had to alleviate negative polling in order to facilitate closure of the panels of the cell structure. This was difficult as the magnets had to attract a pull force at the end of the car protector through two complete panels.

I tried mechanical hinges because they had to be strong to avoid breakage, they were liable to mark the car. They would rotate 180 degrees which was not safe installation.

The focus was to design a cost-efficient solution minimising human labour and axillary parts that could be broken or detached. I therefore decided that the car protector had to be moulded in one piece, injected moulded. The most responsible material was silicon. To save weight and to maximise the dispersion of energy, I decided to design the back in a honeycomb cell structure, saving weight made the cost more economical both for production, freight and application. Reducing the total weight for maximum adhesion for the rare earth magnets. The advantage of the design in silicon is that it is soft and pliable being able to bend around car door profiles. The matt surface of silicon is unobtrusive and stylistic.

The advantage of silicon is that it can be digitally printed on the surface, being a great advantage for company branding and totally weatherproof. I designed the density of the silicon to be soft enough for protection against marking the car duco, but strong enough to enable the design to be reduced to a perfect brick shape for easy storage. The printing being digital cannot bleed colour and the silicon cannot bleed colour onto the duco.

The invention provides a method of providing temporary protection to a vehicle by formation of a vehicle protector, including the steps of:
a) Providing plurality of elongated body portions from a resilient cushioning material
b) Providing at least one hinge connecting two linearly adjacent of the plurality of elongated body portions elongated body portions
c) Including insertion of magnets to provide ability to affix to a metallic vehicle using a magnetic effect without causing electrical interference.

The method can have a plurality of the hinges at linearly spaced locations between linearly adjacent elongated body portions to form multi folds of the elongated body sections from a linearly extending operative form and a folded linearly overlapping storage form and wherein the hinges are on alternating one or other outer side of the outer continuous layer wherein the location and insertion of magnets are offset to each other in different hinged segments so that when in a folded position magnets in each segment retain spacing in a folded storage mode but are all operative on the one side in an unfolded in use mode.

The formation of a vehicle protector, including the steps of a single mould providing an elongated body having a plurality of integrally hinged segments to form and the location and insertion of magnets are into slits in side walls of the segments into pockets which are offset to each other in different hinged segments so that when in a folded position magnets in each segment retain spacing in a folded storage mode but are all operative on the one side in an unfolded in use mode.

The formation of a vehicle protector is preferably in one novel form primarily of silicone.

Other aspects of the invention are also disclosed.

### BRIEF DESCRIPTION OF THE DRAWINGS

Notwithstanding any other forms which may fall within the scope of the present invention, a preferred embodiment of the invention will now be described, by way of example only, with reference to the accompanying drawings in which:

FIG. 1 is a diagrammatic side view of a vehicle with a vehicle protector attached in accordance with a preferred embodiment of the present invention;

FIG. 2 is a diagrammatic front view of a vehicle with a vehicle protector attached in accordance with a preferred embodiment of the present invention;

FIG. 3 is a diagrammatic front and rear view of an elongated vehicle protector attached in accordance with a preferred embodiment of the present invention;

FIG. 4 is a detail of FIG. 3 showing a cross-section of the elongated vehicle protector and highlighting the variation of structure to form a hinge and therefore foldability of the elongated vehicle protector;

FIG. 5 is a diagrammatic view of the elongated vehicle protector of FIG. 3 having a plurality of segments and hinge formations so as to be able to fold to a beneficial W formation that is readily transportable and storable;

FIG. 6 is a diagrammatic view of the elongated vehicle protector of FIG. 3 having a plurality of segments and differently located hinge formations so as to be able to fold to a beneficial W formation that is readily transportable and storable;

FIG. 7 is a diagrammatic view of the elongated vehicle protector of FIG. 3 having a plurality of segments and oppositely located hinge formations so as to be able to fold in opposite directions to a beneficial closed formation that is readily transportable and storable;

FIG. 8 is a diagrammatic view of a detail of FIG. 3 showing the inclusion of magnetic patches forming the detachable attachment means to the vehicle;

FIG. 9 is a detail of the magnetic patches of FIG. 8;

FIGS. 10A and 10B are separate views forming FIG. 10 and comprising a continuing diagrammatic top view, under side view and side view of a vehicle protector with hinge connectable sections in accordance with a second preferred embodiment of the present invention;

FIG. 11 is a diagrammatic view of a hinge in the form of a centre hinge cap and diagrammatic view of connection to two linearly adjacent elongated body sections;

FIG. 12 is a diagrammatic view of a hinge in the form of a outer hinge cap and diagrammatic view of connection to two linearly adjacent elongated body sections;

FIG. 13 is a diagrammatic unfurled view of a further embodiment of the vehicle protector of the invention formed from single moulded structure in foldable W-shaped form;

FIG. 14 is an overhead view of a section of the further embodiment of the vehicle protector of FIG. 13;

FIG. 15 is a side view a diagrammatic folded view of a further embodiment of the vehicle protector of the invention formed from single moulded structure in foldable W-shaped form;

FIG. 16 is a diagrammatic box diagram of the process steps in a method of providing temporary protection to a vehicle in accordance with a first preferred embodiment of the present invention using continuous material and material hinge; and

FIG. 17 is a diagrammatic box diagram of the process steps in a method of providing temporary protection to a vehicle in accordance with a second preferred embodiment of the present invention using separate hinge between elongated bod portions.

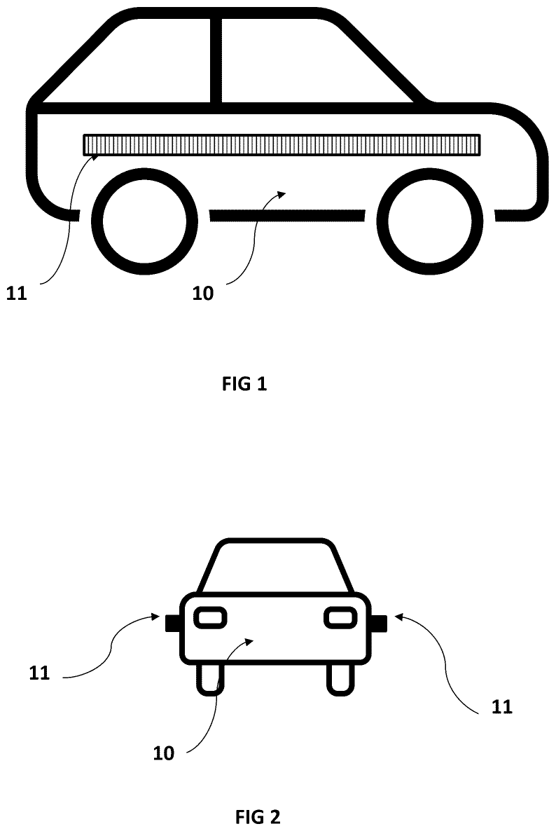

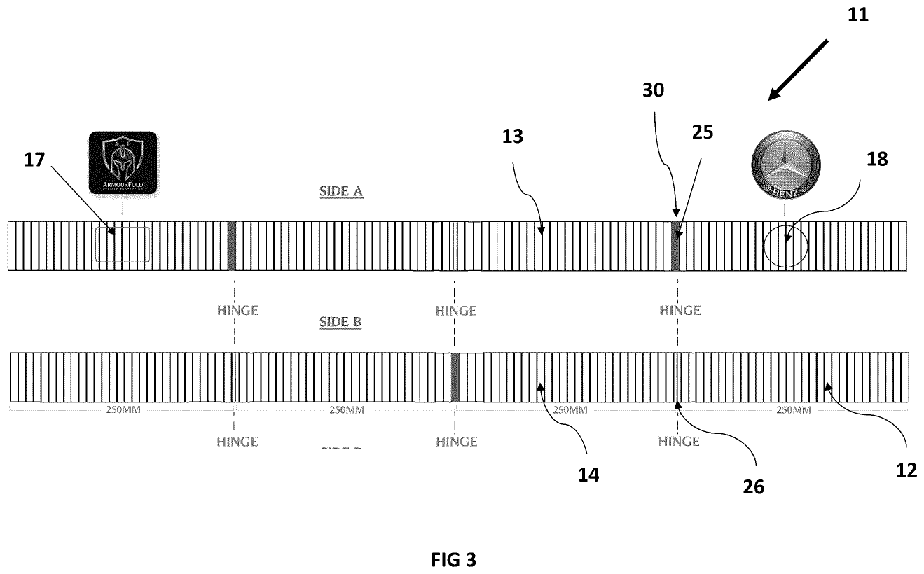

### DESCRIPTION OF PREFERRED EMBODIMENTS

It should be noted in the following description that like or the same reference numerals in different embodiments denote the same or similar features.

Referring to the drawings there is shown a vehicle having an elongated body 12 for removably affixing to a vehicle 10 for protection. Preferably the elongated body 12 is attached along the side of the vehicle at the outermost lateral position. Most vehicles have a shaping of the side panels and the most likely location for damage is the proudest outermost portion. However, some (sport utility vehicles) SUVs and other vehicles are quite high and therefore the most important zone to be protected is down lower at the level of the shopping trolley contact point etc.

The elongated body 12 of the vehicle protector has a front surface 13 and a rear surface 14. The front surface 13 of the vehicle protector 11 can provide a badge receiving surface 18 and include a printing or decal receiving surface for applying commercial advertising 17.

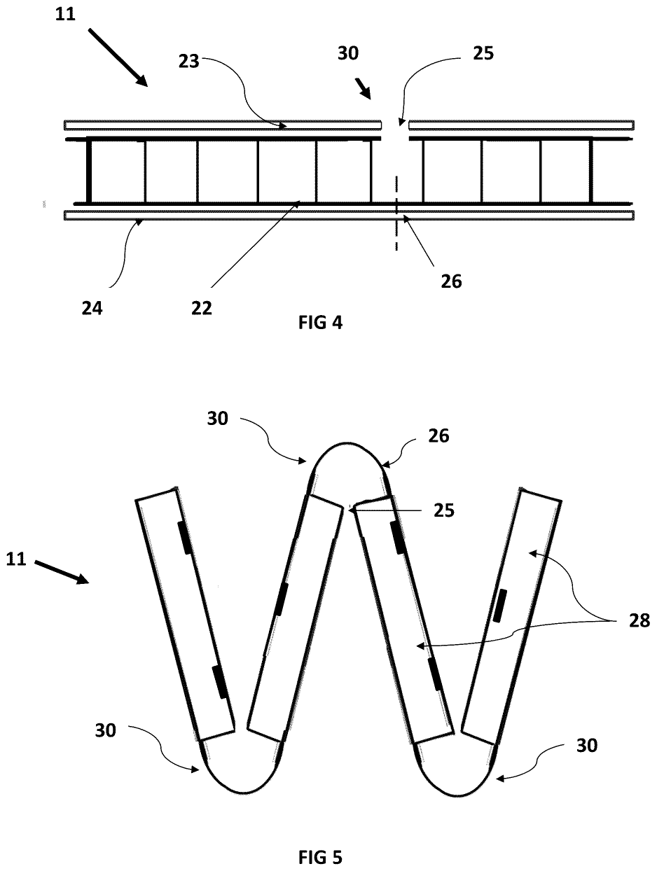

As shown in FIG. 4, the elongated a base matrix layer 22 which in use of the product provides as cushioning effect. Therefore such base matrix layer can be a fluted material, a corrugated material, a boxed or honeycomb cross sectional structure etc. The base matrix layer 22 can be covered by a sheet top layer 23 and bottom layer 24, However such layers could be integral with the base matrix layer22. Multiple base layer 22 can be included to increase the cushioning.

A layer of the product, acting as a cover which can be the top layer 22, base layer 24 or matrix layer 22 or combination thereof, can at spaced locations be modified to break the continuous top or bottom surface and allow the other surface to become a live hinge.

### Example 1

The base matrix layer is a complex structure having at least one layer of corrugated structure and at least one layer of sheeting wherein at least one layer of sheeting acts as a hinge.

The complex structure includes a cut line to at least layer of sheeting which acts as a hinge for the complex structure. The vehicle protector 11 is able to adapt between a storage folded mode and an unfolded in operation mode for attaching to the vehicle to provide a cushioning protector to the vehicle.

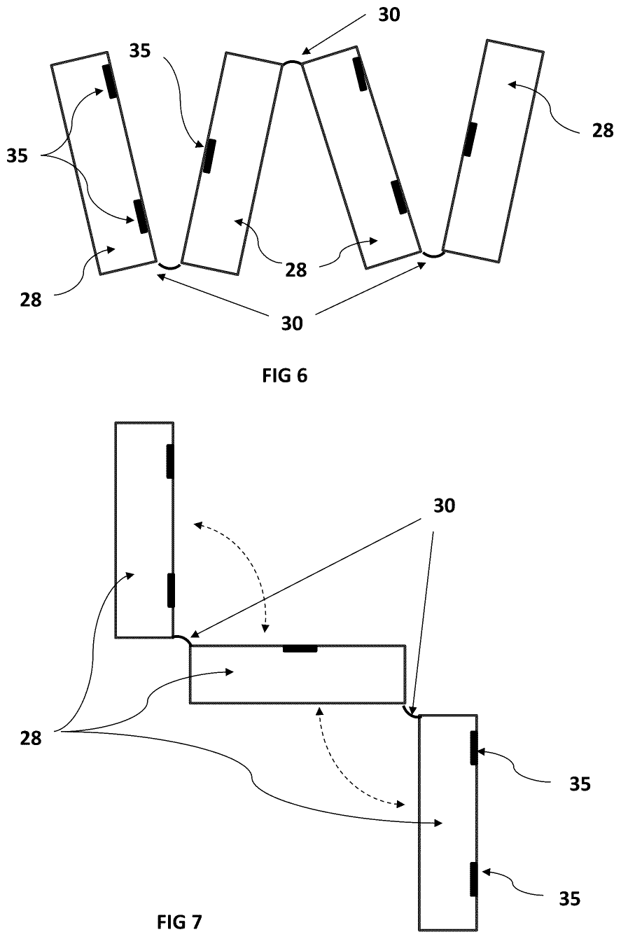

The complex structure can include three or four sections of a fluted corrugated structure having one side of the channel removed to allow it to be folded. Referring to FIGS. 5, 6 and 7 there are shown various embodiments of hinged sections 28 joined by hinges 30 such as shown formed in FIG. 4. In one preferred form of FIG. 6, four hinged sections of the complex structure allow folding to create a unique W shape fold design. However, the hinge arrangement could be an added addition such as in FIG. 5. Further the hinges could be on opposing sides such as FIG. 7 so that the segments fold in opposite directions.

An important element of the placement of the magnets 35 in the segments 28 is that they are offset so as to maintain a distance when in the unfolded in use mode or in the folded storage mode. This means in one example that one segment 28 has two spaced magnets 35 near opposing ends of the first segment and the hingedly attached second segment has a magnet 35 in the middle so that in hingedly folding the two segments the middle magnet will fit within the spacing of the two magnets and maintain a working spacing that does not affect each other.

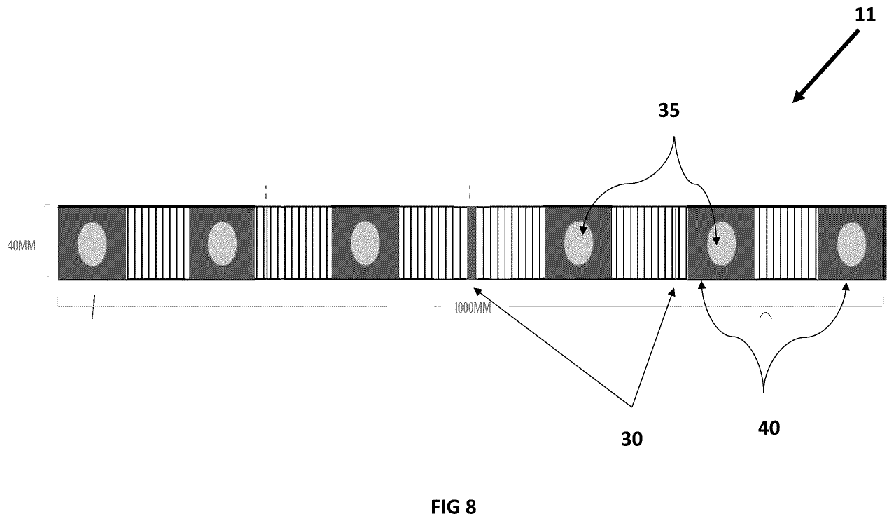

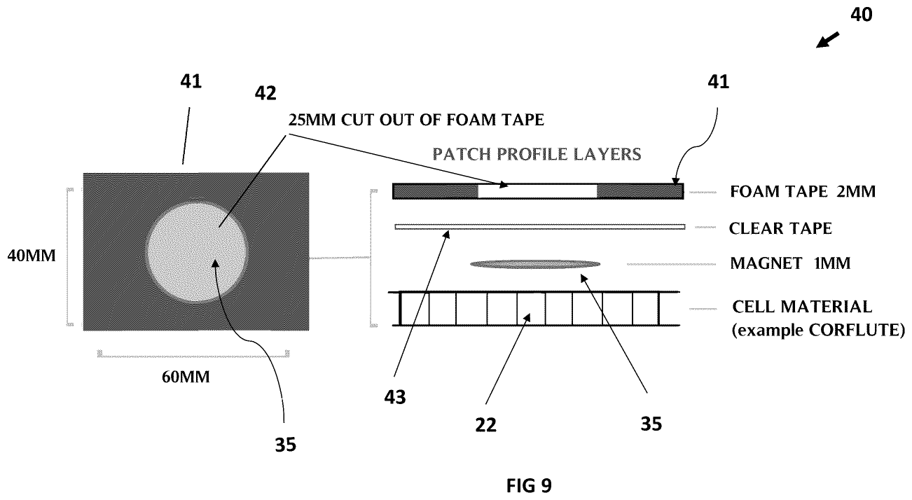

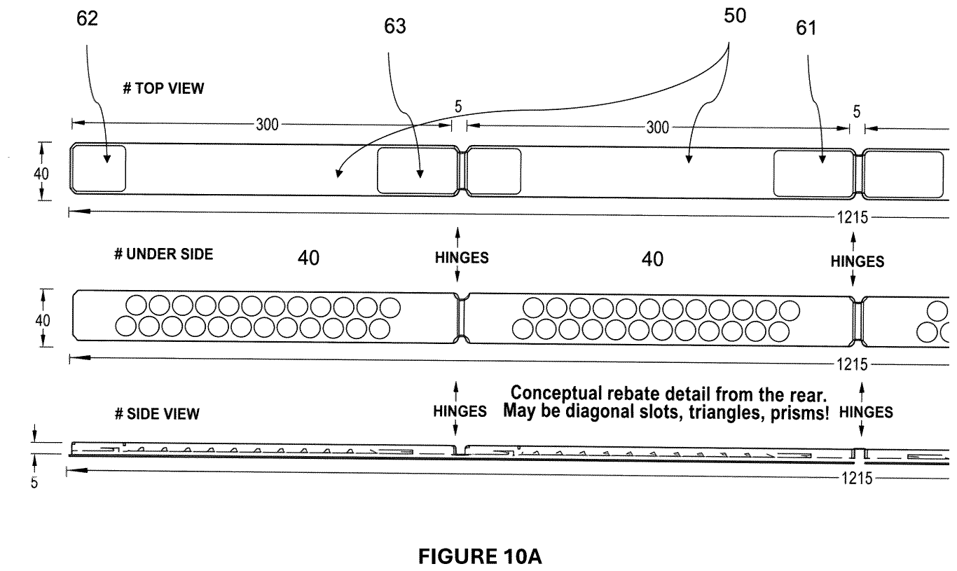

Referring to FIGS. 8 and 9, a location and insertion of magnets can provide affixing means to a metallic vehicle using a magnetic effect without causing electrical interference to the vehicle operational system or vehicle locking system. The location and insertion of magnets to provide affixing to a metallic vehicle using a magnetic effect without causing electrical interference includes a plurality of 25 mm by 1 mm neodymium magnets supported at spaced positions along the length of the elongated body. The location and insertion of magnets is beneath outer layers to control magnetic effect.

A vehicle protector according to claim 1 wherein the location and insertion of magnets is beneath outer layers of 2 or more mm to control magnetic effect.

The magnets 35 used are sufficient to hold, readily removable and not affecting the vehicle electronics. This can be achieved by use of rare earth disc magnets such as neodymium disc magnets. Two preferred forms are:

| | | Pull force | | |
|---|---|---|---|---|
| | | (measured against | Magnetic | |
| | | up to 10 mm | flux | Direction of |
| dimensions | weight | mild steel) | (Gauss) | magnetism |
| 25 mm × 1.5 mm | 5 gm | 2.3 kg | 751 | Axially |
| | | | | magnetised |
| 25 mm × 1 mm | 4 gm | 1.5 kg | 502 | Axially |
| | | | | magnetised |

Referring to FIGS. 8 and 9 a magnetic patch 40 is located at the required spaced locations over the base matrix layer 22. A tape 43 can overlay a rare earth disc magnet 35 to keep it in place. A foam tape of say 2 mm can overlay the tape and thereby space the magnet 2 mm from the front surface of the vehicle protector 11. The foam tape 41 can include 25 mm cutout 42 so as to reveal the magnet 35 while maintaining the magnet the required distance from the surface and to not add to further reduction of effectiveness of the magnet. The magnet can also be of the order of 2 to 5 mm from the edge of the matrix 22 to avoid lateral magnetic interference.

A plurality of these patches 40 form the mounting of the magnets 35 at the required spaced offset locations on each segment of the foldable vehicle protector 11.

The structure of the vehicle protector includes channeling from an upper side to a lower side to provide a drainage structure to resist pooling when used.

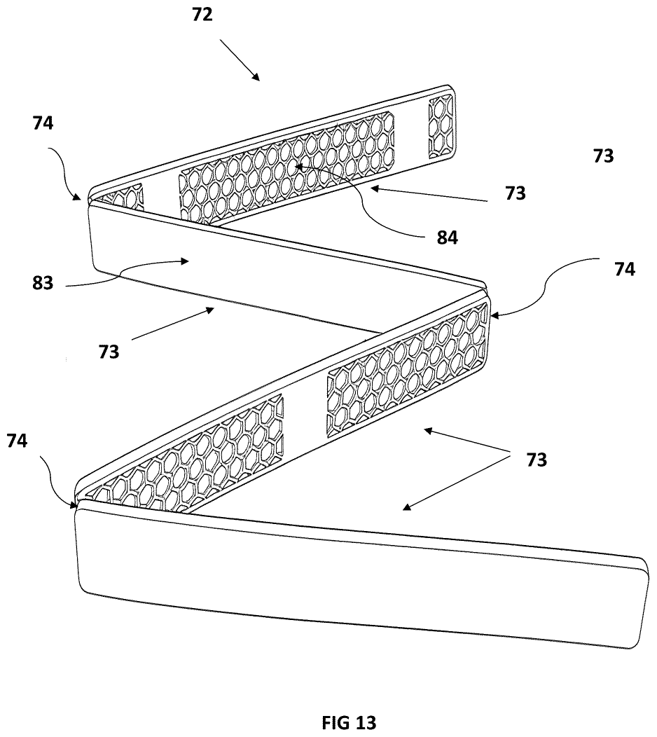

Referring to FIG. 13 the invention includes:
a) Providing a product having a matrix central layer and outer continuous planar layers
b) Providing a continuous elongated shape from the product
c) Providing spaced cuts on outer continuous layer on one side and through the matrix material to form the other outer continuous layer as a live hinge at that location
d) Including insertion of magnets to provide ability to affix to a metallic vehicle using a magnetic effect without causing electrical interference; and
e) adapting between a storage folded mode and an unfolded in operation mode for attaching to the vehicle to provide a cushioning protector to the vehicle.

Details and benefits of the invention include:

### A) Use of Product

The primary use of the product is to eliminate compaction and dents caused to car doors, utilising a simple attachment method both on and off a car.

### B) Modification of Product to Use 1 Layer as a Live Hinge.

The design prerequisite was to envisage a product that could be folded for ease of use and storage. ie glove box, handbag etc. It has been designed to be attached in 1 second and removed the same, to make the product user friendly. Thus, presenting the design of the W Fold. By perforating the material, we were able to create internal and external hinges without any external product or material. Thereby maintaining the structural strength of the material eliminating any superfluous flexing. The method of hinge construction allows the product to be folded to a convenient size for ease of use and storage.

C) Location and Insertion of Magnets to Provide a Magnetic Effect without Causing Electrical Interference

The attachment method and placement of the rare earth magnets was designed in spacing to eliminate internal magnetic polling in folding the product. By calculating the strength of the magnetic force north to south of the attaching magnets to give sufficient secure attachment, eliminating negative polling on the folding of the car door protector. Eliminating negative polling east to west with added memory foam which eliminated external magnetic attraction when the product is folded for storage.

### D) the Covering Layer

A patch fitting was designed of 2 elements which consists of a clear weatherproof seal and memory foam. The clear film provides a secure attachment of the magnet to the product. By covering the magnet with the weatherproof film, it eliminates any oxidation of the magnet and protects the magnet in case of accidental breakage. The memory foam attached externally was designed to give a riser of 1 mm around the prolific circumference of the magnet to absorb external compaction of force without damage to the magnet or the car.

### E) the Draining Structure to Resist Pooling.

By utilising the existing product, it has been designed to expose cell structure to allow flow of water through the product. Thus, eliminating pooling of water in storage.

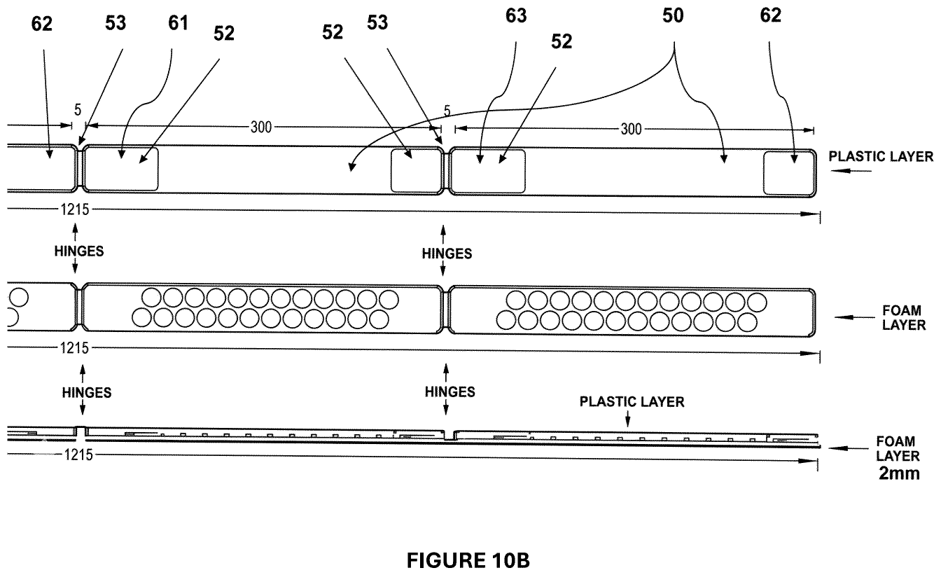

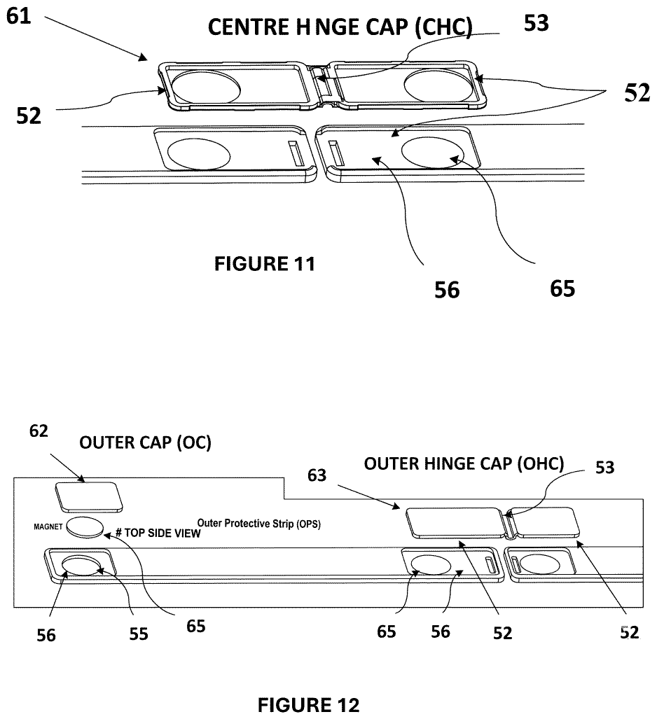

Referring to FIGS. 10 to 12, another embodiment of the vehicle protector having an elongated body for removably affixing to a vehicle for providing protection from low-level impacts. However, the plurality of elongated body sections are connected by at least one hinge connecting the longitudinal ends of two linearly adjacent elongated body sections. Instead of the material forming the hinges, separate hinges connect the elongated body sections.

Further, an insertion of magnets are still located at predefined locations to provide affixing to a metallic vehicle using a magnetic effect without causing electrical interference. In this way the vehicle protector is able to adapt between a storage folded mode and an unfolded in operation mode for attaching to the vehicle to provide a cushioning protector to the vehicle.

### Example 2

In a further embodiment, with reference to FIGS. 10 to 12 there is shown a vehicle protector wherein the at least one hinge 61, 63 which is formed separately and connects parts of the elongated sections 50.

The at least one hinge 61, 62 is formed of plastic with separate tabs 52 on either side of a live hinge 53 such that the separate hinges connects to parts of the elongated body sections 50 and provides a hinge effect in between. The hinge 61, 63 is a live hinge 53 integral with the tabs 52, wherein the hinge is a mechanical hinge connected between the tabs.

However, the hinge is one of a plurality of hinges 61, 63 formed connecting a plurality of linearly aligned elongated body sections 50. The plurality of at least one hinge comprises at least one of the type of:
a) An outer hinge cap 63 having two tabs 52 with a live hinge 53 allowing for folding inwards over each other;
b) A centre hinge cap 61 and having two tabs 52 with a live hinge 53 allowing for folding outwards away from each other but overlapping;
c) An outer cap 62 having a single tab 52 for fitting in single recess 56 at the ends of elongated body portions 50 not requiring hinges 61, 63.

The tabs connect to the material of the elongated sections and the plurality of at least one hinge allow for folding between a continuous elongated form and a folded overlapping form.

The tabs 52 are shaped and sized to fit into tab recesses 56 in the elongated boy portions 50. Closure clips lock the plastic hinge to the body portion.

However, the tabs 52 and elongated body portions 50 include magnet housings 55 within the tab recesses 56 that provide a location for insertion and retention of magnets 65 which provide affixing to a metallic vehicle using a magnetic effect without causing electrical interference to the vehicle. In this way the tabs receive the magnets 65 and attach to the material of the elongated sections 50, while substantially preventing access to the magnets.

The magnets are offset such that they substantially do not overly each other in a folded form of the design of the W Fold.

The location and insertion of magnets to provide affixing to a metallic vehicle using a magnetic effect without causing electrical interference includes a plurality of 25 mm by 1 mm neodymium magnets supported at spaced positions along the length of the elongated body. In particular the location and insertion of magnets are offset to each other in different hinged segments so that when in a folded position magnets in each segment retain spacing in a folded storage mode but are all operative on the one side in an unfolded in use mode. The location and insertion of magnets is most preferably beneath outer layers to control magnetic effect.

This location and insertion of magnets has the benefit of:
a) locatable beneath outer layers of 2 or more mm to control magnetic effect.
b) Out of the way such that no external damage to the vehicle can occur
c) Offset of the magnets so no “locking” of overlapping magnets occurs
d) Security of magnets so not a child hazard

### Example 3

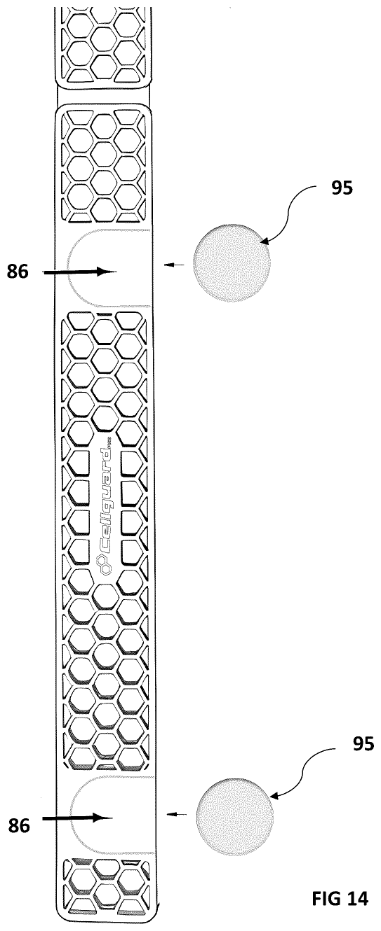

In this embodiment of the vehicle protector 71 as shown in FIGS. 13, 14 and 15 have the structure and characteristics of the vehicle protector still comprise an elongated body for removably affixing to a vehicle for providing protection from low-level impacts

The vehicle protector 71 comprises in this embodiment an elongated body 72 with a plurality of segments 73 connected with integral hinges 74. These hinges connect the longitudinal ends of two linearly adjacent elongated body sections.

The vehicle protector is able to adapt between a storage folded mode and an unfolded in operation mode for attaching to the vehicle to provide a cushioning protector to the vehicle. Similarly to the embodiment 4 segments 28 of FIG. 5 the segments 73 of the embodiment shown in FIG. 13 have integral hinges 30, 74 that alternate so that the elongated body can fold into a W-configuration compact arrangement as shown in FIG. 13.

The elongated body 72 has an outer surface 83 that faces outwards when mounted on a car. The surface can be coloured to match the vehicle, include trade marks or include marketing information. In one version the body could include advertising or instructional information such as to contact the sales person when it is attached to a vehicle. In this way it is increasing sales while protecting entry to vehicles.

The structure includes inner surface 84 which is formed in single moulded unit of segments 73 with hinges 74. The segments include inner surface portions which are multiple hexagonal beehive design with open ends so as to allow single open mould, reduction of weight of article while retaining strength and also allowing flexibility of behive walls to allow softened resilient contact with the vehicle.

The unique W fold design concertina into a rectangular compact soft brick that is space saving and provides ease of application. It can be easily stored in car door in folded form or under the seat or in the glove box, and is easily unfolded to an extended elongated form for application and use on the exterior surface of the vehicle.

An insertion of magnets 95 inserted into side slits 85 of the single moulded form at predefined locations to provide affixing to a metallic vehicle using a magnetic effect without causing electrical interference. The magnets are sized to require deformation of the strong resilient slits 85 to require force to insert into the internal receiving magnet cavity inner pocket 86 and virtually prevent the removal of the inserted magnets. This forms a safe, virtually tamperproof product.

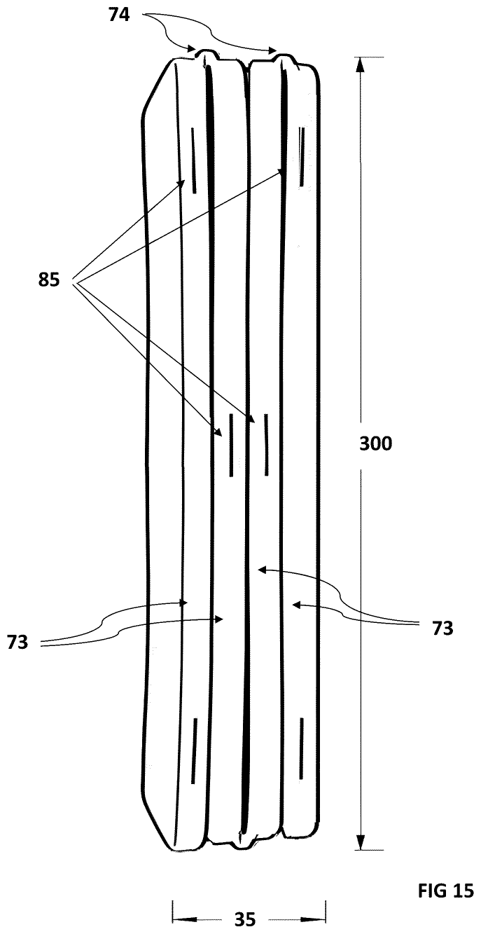

There are 6 magnets 95 spread along the elongated body 72 to ensure maximum adhesion while not affecting electronics. The magnets are offset such that when in a folded format as shown in FIG. 15 adjacent segments 73 have offset slits 85 and offset inner pockets 86 so as to not affect folding. That is the double thickness of material will provide sufficient spacing of magnets to not be repulsing each other and will not prevent folding. The weaker magnetic force can enhance the folding and locking of the segments into a folded block.

The 25 mm×3 mm round neodymium magnets 95 deliver a pull force of 4.8 kg through the thickness of the thickness of the elongated body ensuring the vehicle protector stays securely attached to the vehicle even at high speeds. Although the product is designed for use while parking and removal when driving, it must be sufficiently operative in case the driver retains the protector on the vehicle while driving.

Made in one single moulded piece of silicone, the vehicle protector is not only soft against car surfaces to prevent scratching but is also robust and able to absorb high impacts to prevent dents to the vehicle.

It is the combination of the material and the structure and the configuration that The structure

This embodiment isn't just a smarter way to protect car doors, it is also a better choice for the environment. Made from premium silicone rather than plastic, the product in this form delivers long term performance while reducing environmental impact in multiple ways including one or more of:
1. Longer Lifespan—as the product's silicone structure of this embodiment is more durable and resistant to cracking, hardening and degradation, meaning fewer replacements and less waste compared to plastic car protectors.
2. Heat Resistance—Unlike plastic protectors, this embodiment withstands extreme temperatures without melting, warping or releasing toxic fumes.
3. Cold Resistance—Silicone keeps the product flexible and functional even in freezing conditions, whereas plastic can become brittle and break.
4. Non-Toxic Stability—the product is made from chemically inert silicone that does not leach harmful chemicals like BPA or phthalates into the environment.
5. Reusable & Long-Term Use—Designed for repeated daily use, the product reduces the demand for disposable or short lived plastic products.
6. Lower Microplastic Pollution—Silicone used in the product breaks down into silica, water, and carbon dioxide. Unlike plastics, which fragment into persistent microplastics.
7. Recyclable in Specialized Facilities—can be downcycled into industrial materials, unlike many plastics that are non recyclable.
8. Less Petroleum-Intensive—relies on silicone derived primarily from silica (sand), reducing dependency on crude oil compared to traditional plastic products.
9. Biocompatibility—Silicone is safe for medical and food grade applications, which carries a significantly lower risk of environmental contamination from toxic additives.
10. UV & Weather Resistance—won't degrade or crumble under sunlight or outdoor exposure, reducing litter and environmental breakdown.
11. Mold & Bacterial Resistance—Silicone does not support microbial growth, reducing the need for harsh chemical cleaners that can damage ecosystems.
12. Lower Waste Footprint—as the product is reusable and long-lasting, fewer products end up in landfill compared to disposable or short life plastic alternatives.
13. Energy Efficiency Over Time—requires fewer replacements, resulting in lower total energy usage across manufacturing and distribution over its lifespan.
14. Safe Incineration—silicone produces mostly silica, water vapor and small traces of carbon dioxide-unlike plastics that emit toxic gases and dioxins.
15. Supports Circular Economy Practices—which enables companies and consumers to choose durable, reusable materials over disposable plastics, driving more sustainable product cycles.

### Method of Use

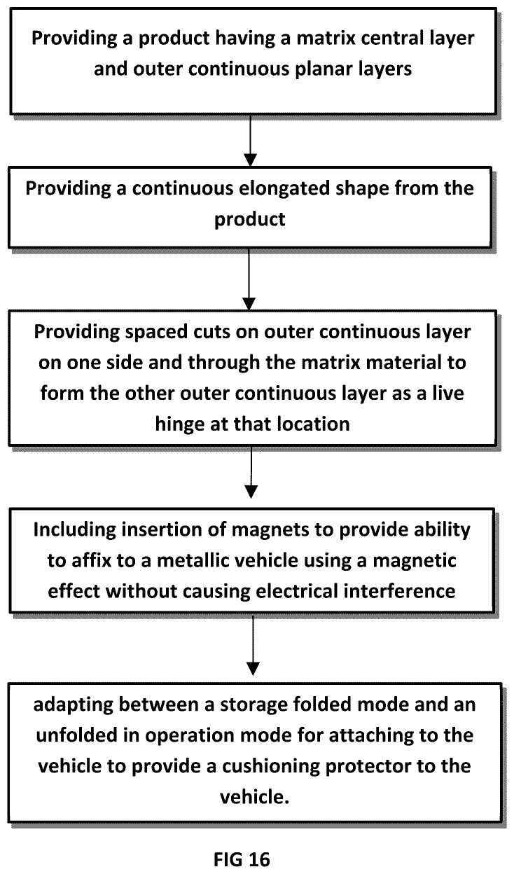

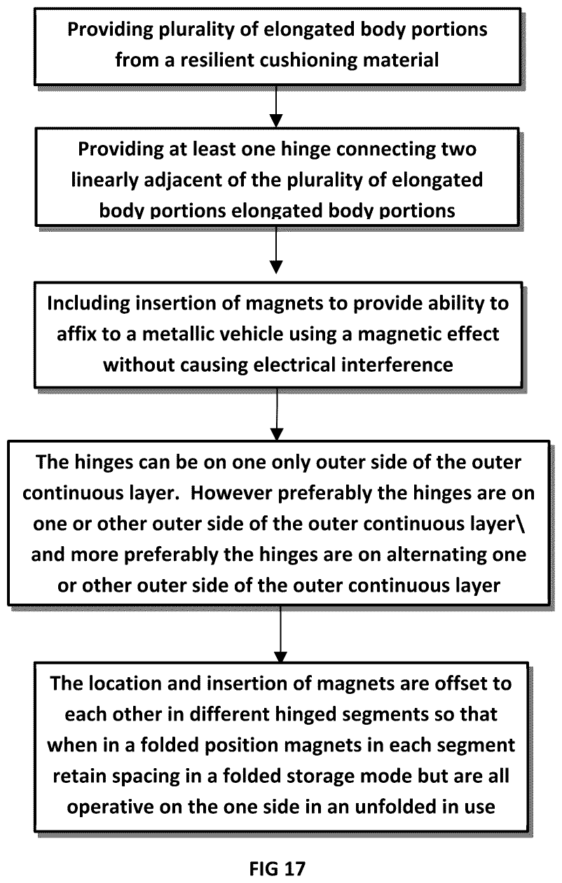

Referring to FIGS. 16 and 17, the invention also provides a method of providing temporary protection to a vehicle by formation of a vehicle protector, including the steps of:
a) Providing plurality of elongated body portions from a resilient cushioning material
b) Providing at least one hinge connecting two linearly adjacent of the plurality of elongated body portions elongated body portions
c) Including insertion of magnets to provide ability to affix to a metallic vehicle using a magnetic effect without causing electrical interference.

A plurality of the hinges are at linearly spaced locations between linearly adjacent elongated body portions to form multi folds of the elongated body sections from a linearly extending operative form and a folded linearly overlapping storage form.

The hinges can be on one only outer side of the outer continuous layer. However preferably the hinges are on one or other outer side of the outer continuous layer\ and more preferably the hinges are on alternating one or other outer side of the outer continuous layer.

The location and insertion of magnets are offset to each other in different hinged segments so that when in a folded position magnets in each segment retain spacing in a folded storage mode but are all operative on the one side in an unfolded in use mode.

Other embodiments would be understood by a skilled person in the art and are included within the scope of the invention.

### Interpretation

### EMBODIMENTS

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the motor vehicle and surface protection industries.

What is claimed is:

1. A vehicle protector having an elongated body for removably affixing to a vehicle for providing protection from low-level impacts comprising:
a. a plurality of elongated body sections;
b. at least one hinge connecting the longitudinal ends of two linearly adjacent elongated body sections;
c. an insertion of magnets at predefined locations to provide affixing to a metallic vehicle using a magnetic effect without causing electrical interference
wherein the vehicle protector is able to adapt between a storage folded mode and an unfolded in operation mode for attaching to the vehicle to provide a cushioning protector to the vehicle.

2. A vehicle protector according to claim 1 wherein the magnets are offset so that they are spaced from each other in the folded and unfolded modes.

3. A vehicle protector according to claim 1 including three or four linearly aligned elongated sections and the hinge formation allows folding to create a unique W shape in folded mode.

4. A vehicle protector according to claim 1 wherein the plurality of at least one hinge comprises at least one of the type of:
a. An outer hinge cap having two tabs with a live hinge allowing for folding inwards over each other;
b. A centre hinge cap and having two tabs with a live hinge allowing for folding outwards away from each other but overlap;
wherein the tabs connect to the material of the elongated sections and the plurality of at least one hinge allow for folding between a continuous elongated form and a folded overlapping form.

5. A vehicle protector according to claim 1 wherein the structure includes inner surface which is formed in single moulded unit of segments with hinges.

6. A vehicle protector according to claim 5 wherein the formation of a vehicle protector is primarily of silicone.

7. A vehicle protector according to claim 5 wherein the structure includes segments having inner surface portions which are multiple hexagonal beehive design with open ends so as to allow single open mould, reduction of weight of article while retaining strength and also allowing flexibility of beehive walls to allow softened resilient contact with the vehicle.

8. A vehicle protector according to claim 5 wherein the tabs include a location and insertion of magnets which provide affixing to a metallic vehicle using a magnetic effect without causing electrical interference to the vehicle.

9. A vehicle protector according to claim 5 wherein the tabs receive the magnets and attach to the to the material of the elongated sections, while substantially preventing access to the magnets.

10. A vehicle protector according to claim 9 wherein structure is formed from a single mould providing an elongated body having a plurality of integrally hinged segments to form and the location and insertion of magnets are into slits in side walls of the segments into pockets which are offset to each other in different hinged segments so that when in a folded position magnets in each segment retain spacing in a folded storage mode but are all operative on the one side in an unfolded in use mode magnets are offset such that they substantially do not overly each other in a folded form.

11. A vehicle protector according to claim 10 wherein the location and insertion of magnets to provide affixing to a metallic vehicle using a magnetic effect without causing electrical interference includes a plurality of 25 mm by 1 mm neodymium magnets supported at spaced positions along the length of the elongated body.

12. A vehicle protector according to claim 11 wherein the location and insertion of magnets are offset to each other in different hinged segments so that when in a folded position magnets in each segment retain spacing in a folded storage mode but are all operative on the one side in an unfolded in use mode.

13. A vehicle protector according to claim 11 wherein the location and insertion of magnets is in pockets between outer layers of 2 or more mm to control magnetic effect.

14. A method of providing temporary protection to a vehicle including the steps of:
a. providing a product having a matrix central layer and outer continuous planar layers;
b. providing a continuous elongated shape from the product;
c. providing spaced cuts on outer continuous layer on one side and through the matrix material to form the other outer continuous layer as a live hinge at that location;
d. including insertion of magnets to provide ability to affix to a metallic vehicle using a magnetic effect without causing electrical interference.

15. A method according to claim 14 wherein the location and insertion of magnets are offset to each other in different hinged segments so that when in a folded position magnets in each segment retain spacing in a folded storage mode but are all operative on the one side in an unfolded in use mode.

16. A method according to claim 14 of providing temporary protection to a vehicle by formation of a vehicle protector, including the steps of:
a. Providing plurality of elongated body portions from a resilient cushioning material;
b. Providing at least one hinge connecting two linearly adjacent of the plurality of elongated body portions elongated body portions;
c. Including insertion of magnets to provide ability to affix to a metallic vehicle using a magnetic effect without causing electrical interference.

17. A method according to claim 16 wherein a plurality of the hinges are at linearly spaced locations between linearly adjacent elongated body portions to form multi folds of the elongated body sections from a linearly extending operative form and a folded linearly overlapping storage form and wherein the hinges are on alternating one or other outer side of the outer continuous layer wherein the location and insertion of magnets are offset to each other in different hinged segments so that when in a folded position magnets in each segment retain spacing in a folded storage mode but are all operative on the one side in an unfolded in use mode.

18. A method according to claim 17 wherein the formation of a vehicle protector, including the steps of a single mould providing an elongated body having a plurality of integrally hinged segments to form and the location and insertion of magnets are into slits in side walls of the segments into pockets which are offset to each other in different hinged segments so that when in a folded position magnets in each segment retain spacing in a folded storage mode but are all operative on the one side in an unfolded in use mode.

19. A method according to claim 18 wherein the formation of a vehicle protector is primarily of silicone.
